(19) United States
(12) Patent Application Publication
(10) Pub. No.: US 2010/0047438 A1
(43) Pub. Date: Feb. 25, 2010

(54) UNIFORMLY COLOURED CERAMIC FRAMEWORK AND COLOURING SOLUTION

(75) Inventors: Holger Hauptmann, Sindelsdorf (DE); Peter Bissinger, Diessen (DE)

Correspondence Address: 3M INNOVATIVE PROPERTIES COMPANY, PO BOX 33427, ST. PAUL, MN, 55133-3427, US

(73) Assignee: 3M ESPE AG (a wholly-owned subsidiary of 3M COMPANY)

(21) Appl. No.: 12/610,745

(22) Filed: Nov. 2, 2009

Related U.S. Application Data
(62) Division of application No. 10/560,702, filed on Dec. 13, 2005.

(30) Foreign Application Priority Data
Jun. 13, 2003 (EP) 03 013 513.1

(51) Int. Cl. A61C 13/00

(52) U.S. Cl. 427/2.29

(57) ABSTRACT

The present invention relates to a colouring solution for ceramic framework, the ceramic framework coloured with the solution as well as a process to obtain a uniformly coloured ceramic framework. The solution comprises a solvent, a metal salt and polyethylene glycol having a Mn in the range of 1.000 to 200.000.

### CROSS-REFERENCE TO RELATED APPLICATIONS

This application is a divisional of pending prior U.S. application Ser. No. 10/560,702, filed Jun. 9, 2004, which is a national stage filing under 35 U.S.C. 371 of PCT/EP2004/06220 filed Jun. 9, 2004, which claims priority to European Patent No. 1486476, which are all incorporated herein by reference.

The present invention relates to a colouring solution for ceramic framework, the ceramic framework coloured with the solution as well as a process for obtaining a uniformly coloured ceramic framework.

Ceramic framework is usually coloured with metal salt solutions. For that purpose salt solutions are applied on the ceramic or the framework itself is dipped into the solution. The framework is dried afterwards and fired to fix the colour.

In this respect DE 196 19 168 A1 describes a ceramic colouring solution consisting essentially of water and a palladium containing compound dissolved therein. The solution might further contain cosolvents such as alcohols, glycols, glycol ether or polyethylene glycol.

DE 196 19 165 C1 A1 refers to a similar solution containing a mixture of Ti and Fe components.

WO 00/46168 A1 refers to colouring ceramics by way of ionic or complex-containing solutions containing defined concentrations of at least one salts or complexes of the rare earth elements or of the elements of the subgroups. The solution might contain additives like stabilizers, complex builders, pigments and beating additives.

Disadvantageous in the processes described in the prior art is that forces occurring during the drying and/or firing process might cause migration of metal ions towards the surface in an inhomogeneous way thereby disturbing the aesthetics of the whole prosthodontic work.

One way to prevent migrations of that type might be the addition of soluble substances of high molecular weight. This usually affects the diffusion of all ingredients and thereby leads to the desired effect.

On the other hand such additives usually lead to a substantial increase in viscosity and may lead to an altered wetting behaviour by modification of the overall polarity of the system. Such effects result often in lower penetration of the solution into the pores of the ceramic and thereby increase the working time unduly.

Another drawback might be that polymeric additives may decrease the solubility of metal ions by binding great portions of the water available and also may decrease the shelf live stability of the solution by facilitating precipitation or being prone to degradation.

Any additive must also be thermally degradable during the firing process without leaving ay residue or affecting the composition and integrity of the ceramic framework.

Therefore, it is an object of the present invention to provide a colouring solution for ceramic framework having improved properties.

A further object is to provide a colouring solution for ceramic framework that prevents the disadvantageous separation tendencies, however, maintaining all other desired properties of the system.

Still a further object is to provide a colouring solution leading to less sintering deformation of ceramic framework after firing.

Still a further object is to provide a colouring solution leading to a uniformly coloured ceramic framework.

Surprisingly it has been found that providing a solution comprising
a metal salt,
polyethylene glycol or derivatives thereof having a Mn in the range of about 1.000 to about 200.000
a solvent and
optionally a stabilizer
   wherein the polyethylene glycol is present in an amount of about 0.5 to about 10% by weight of the total composition
   addresses the problems mentioned above.

Therefore, the present invention relates to a solution for colouring ceramic framework, ceramic framework coloured with said solution and a process for colouring a ceramic framework.

The addition of polyethylene glycol or derivatives thereof surprisingly shows no detrimental effect on the viscosity and does not affect the shelf life stability of the solution.

On the contrary, surprisingly given due to stabilization of the additive against oxidative degradation the additive even sustained shelf life stability by preventing basic salts to precipitate.

A further positive and surprising effect using polyethylene oxides and derivatives thereof is the positive influence on the deformation occurring during the sintering process. Using the inventive colouring solution it is thus possible to improve the fit of wide spanning frameworks (more than 3 units).

Additionally there is no absolute need for the dental technician to use pressure during the infiltration process as it is suggested in the current instruction manual of Lava™ Frame of 3M ESPE AG; edition 08/02.

The terms “comprise” and “contain” within the meaning of the invention introduce a non exhaustive list of features. Likewise, the word “one” is to be understood in the sense of “at least one”.

The inventive solution can be applied to presintered ceramic bodies of various compositions, especially such comprising or preferably consisting essentially of ZrO₂ and/or Al₂O₃, respectively. These compositions are known to the skilled person in the art (cf. for example WO 00/4618 A1). The ZrO₂ is preferably stabilized with Y₂O₃.

Metal salts useful for the colouring purpose are described e.g. in WO 00/46168 A1 especially on page 3. Useful metal salts are preferably selected from rare earth elements or of the subgroups of the rare earth elements like La, Pr and/or Er. Useful are also salts of transition metals of the groups IIIA, IVA, VA, VIA, VIIA, VIIIA, IB, IIB, especially Fe, Co, Ni, Cu and Mn. A combination of Fe, Mn and Er is particularly preferred (cf. Table of Periodic Properties of the Elements; SARGENT-WELCH Scientific Company; Illinois 60077; 1980).

Generally all metal salts soluble in the solvent used can be used. Preferred are metal salts or metal complexes having as anions Cl⁻, Br⁻, J⁻, SO₄²⁻, SO₃²⁻, NO₂⁻, NO₃⁻.

The above mentioned document (WO 00/46168 A1) is explicitly mentioned and its disclosure is incorporated by reference, especially the disclosure relating to metal salts disclosed in the above mentioned location, is regarded as being part of the disclosure of the present invention.

The metal ions are contained in the solution in an amount sufficient to achieve an adequate colouring of the ceramic framework.

Good results can be achieved e.g. with amounts in the range of about 0.01 to about 15.0% by weight of metal ions, preferably in the range of about 0.1 to about 10.0% by weight, more preferably in the range of about 0.1 to about 7.0% by weight.

Polyethylene oxide or derivatives of polyethylene oxide in the meaning of the present invention are generally prepolymeric polyethers predominantly comprising —(CH₂—CH₂—O)— groups.

The polyethylene glycol should preferably be dissolvable or dispersible in the solvent containing appropriate amounts of metal ions as mentioned above.

There is a great variety of such substances available on the market starting from simple polyethylene glycols to end group modified polyethylene oxides, di- tri- and multi block copolymers with other prepolymers, preferably polypropylene oxides and poly-THF, end group modified species and ethoxylated backbones of any type using mono-, di- and polyhydroxy compounds as starting materials for the polymerisation of the ethylene oxide.

The polyethylene oxide used can preferably represented by formula (1)

R¹O—(CH₂—CH₂—O)ₘ—R¹ (1)

with R¹═H, Acyl, Alkyl, Aryl, Alkylaryl, Polypropylglycol, Poly-THF, preferably H, Acetyl, Methyl, Ethyl, Propyl, Butyl, Hexyl, Octyl, Nonyl, Decyl, Lauryl, Tridecyl, Myristyl, Palmityl, Stearyl, Oleyl, Allyl, Phenyl, p-Alkylphenyl, Polypropyleneglycol, Poly-THF and
m=about 20 to about 5,000, preferably about 200 to about 2,000, more preferably about 400 to about 1,000
or formula (2)

R²—[(OCH₂—CH₂)ₙ—OR¹]ₚ (2)

with R²=any organic residue with p anchor points for ethoxylation and about 3 to about 30 carbon atoms or a prepolymer of propylene oxide or tetrahydrofurane, preferably glyceryl (p=3), TMP (trimethylolpropane-triyl, p=3), TME (trimethylolethane-triyl, p=3), pentaerythritol-tetrayl (p=4), dipentaerythritol-hexayl (p=6), BPA (Bisphenol-A-diyl, p=2), polypropylene glycol-diyl (p=2) and polytetramethylene glycol-diyl (p=2),
m=n*p=about 20 to about 5,000, preferably about 200 to about 2,000, more preferably about 400 to about 1,000 and
p=2 to about 10, preferably 2 to about 6.

P and n a are restricted to values such that the average content of ethylene oxide in the substance exceeds or is equal to about 50% according to the following formula (3):

% ethylene oxide=m*44.05*100/Mn(substance) (3)

Mn (substance) is the average molecular weight of the respective polyether oxide or ethoxylated compound used.

While simple polyethylene glycols show the highest water solubility, segmented derivatives may add tensidic characteristics, if desired.

Besides polyethylene also mixtures of polyethylene and the derivatives can be used.

Preferred examples for the polyethylene oxides mentioned above are:

Poly-(ethylenglykol)-block-poly-(propylenglykol)-block-poly-(ethylenglykol) (Aldrich Art.-No.: 54, 234-2) Mn=14,600, 82.5% ethylene glycol,
Polyethylenglykol (VWR Art. No.: 817008) M=10,000, Hydroxyl number: 9-12,
Polyethylenglycol (VWR Art No.: 818892) M=35,000, Hydroxyl number: 3-4,

### Glycerin-ethoxylat (Aldrich Art.-No.: 40, 186-4) Mn=1,000,

Pentaerythrit ethoxylat (15/4 EO/OH) (Aldrich Art.-No.: 41, 873-0) Mn=797,

### 1,1,1-Trishydroxymethyl-propan-ethoxylat (20/3 EO/OH) (Aldrich Art.-No.: 41,617-7) Mn=1.104,

Polyethylenglycoldimethylether (Aldrich Art.-No.: 44, 590-8) Mn=ca. 2.000 Melting range: 52-55° C.,
Bisphenol A-ethoxylat (15 EO/Phenol) (Aldrich Art. No.: 41, 661-4) Mn=ca. 1.500),
Brij® 700 (Aldrich Art. No.: 46-638-7) Mn=ca. 4.670).

The inventive colouring solution also comprises a solvent. The solvent should preferable be able to dissolve the metal ion(s) used. Typical solvents are water, alcohols like methyl alcohol, ethyl alcohol, iso-propyl alcohol, n-propyl alcohol, ketones like acetone and mixtures of water with alcohols and/or ketones and/or ethylene glycol and/or glycerol.

The number average molecular weight (Mn) of the polyethylene oxide should be in the range of about 1,000 to about 200,000, preferably in the range of about 10,000 to about 100,000, more preferably in the range of about 20,000 to about 50,000.

If the Mn is in the range of about 500 or below, the content of the polyethylene glycol used has to be increased.

If the Mn is above about 200,000, the polyethylene glycol used might be not sufficiently soluble in the solution and a homogeneous mixture is difficult to obtain.

The number average molecular weight (Mn) can be determined according to procedures known to a person skilled in the art as described for example in Arndt/Müller, Polymercharakterisierung, Hanse Verlag, 1996. Depending on the molecular weight to be determined, it might be necessary to apply different measurement methods (see below).

Generally, the polyethylene oxide should be added in an amount so that the desired effect can be obtained and the ceramic framework obtained after firing is uniformly coloured.

The polyethylene oxide can be added in an amount in the range of about 0.5 to about 10% by weight of the colouring solution, preferably in an amount in the range of about 1 to about 8% by weight or in an amount in the range of about 1 to about 5% by weight, or in an amount in the range of about 4 to about 8% by weight.

If the amount is outside the above mentioned ranges, the colouring effect achieved might be not sufficient especially regarding intensity.

Good results can be achieved with a polyethylene oxide having a Mn in the range of about 10,000 and about 50,000, added in an amount of about 4 to about 8% by weight.

The solution used should preferably have an adequate viscosity so that sufficient wetting of and penetration into the pores of the ceramic framework can be achieved. Good results can be obtained with a solution having a viscosity comparable to an aqueous polyethylene glycol solution (about 6% by weight of polyethylene glycol 35,000; Mn=14.000 to 19.000) at 23° C. Polyethylene glycol 35,000 is available from Merck Schuchardt OHG, D-85662 Hohenbrunn.

If the viscosity of the solution is to high, the colour value might be to bright.

If the viscosity of the solution is to low, the colour value might be not homogenous.

Further additives can be added to the colouring solution like stabilizers such as methoxy phenol hydrochinone, Topanol A, ascorbic acid, complex builders such as EDTA, NTA, citric acid, lactic acid and beating additives such as temporary binders, buffers such as acetate or amino buffers and thixotropic substances like polysaccharides, poly vinyl alcohols, cellulose derivatives, carraghenanes, polyvinyl pyrollidone.

The present invention is also directed to a process comprising the steps:
providing a ceramic framework
providing a solution as described above
treating the ceramic framework with the solution as described in b)
optionally drying the treated ceramic framework
firing the treated ceramic framework

Colouring the ceramic framework can be achieved by dipping the framework into the solution. However, the solution can also be applied to the framework by spraying, brushing or by using a sponge or fabric.

The ceramic framework usually is treated with the solution for about 1 to about 5 minutes, preferably about 2 to about 3 minutes at room temperature.

Preferably no pressure is used.

Drying the coloured ceramic framework is not absolute necessary, but preferred to reduce the time needed for firing and to avoid unwanted inhomogenous colour effects.

The firing conditions are dependant on the ceramic material used.

The firing usually takes place for a ZrO₂ based ceramic at a temperature above about 1300° C., preferably above about 1400° C., more preferably above about 1450° C. and lasts for at least about 0.5 h, preferably for at least about 1 h, more preferably for at least about 2 h.

The firing usually takes place for a Al₂O₃ based ceramic at a temperature above about 1350° C., preferably above about 1450° C., more preferably above about 1650° C. and lasts for at least about 0.5 h, preferably for at least about 1 h, more preferably for at least about 2 h.

The present invention relates also to ceramic framework coloured with the inventive solution, and to ceramic framework obtainable by a process as described above.

The coloring solution of the present invention does not necessarily comprise any organic colorants or coloring means that will only tint the surface but not the bulk, like pigments.

The invention is hereinafter described by examples.

To determine the value of Mn for polyethylene glycol having a number average molecular weight in the range of 1,000 to 40,000 the following method can be used:

As an apparatus a Titroprozessor (TIP) is used with a Pt-titrode and a high Ohm reference electrode; chemical agents to be used are: 2 N KOH/methanol; 2.5 ml acetic anhydride solved in 50.0 ml DMF; 2.5 g 4-Dimethylaminopyridin solved in 100 ml DMF (catalytic solvent); THF, H₂O. All substances should be water free (<0.01% water).

A specific amount of the substance to be analyzed is put in a vessel and solved in 20 ml THF, if necessary by warming up. After addition of 10.0 ml catalytic solvent and 5.0 ml acetic anhydride reagent the mixture is stirred in the sealed vessel for 30 min at RT. Thereafter 2.0 ml H₂O is added and the mixture is stirred for another 10 min at RT. The titration is done with 0.2 N KOH/methanol. Three blank values are determined to be used to determine the average value.

The calculation is done as follows:

$$OH \text{-} equivalent = \frac{IW [ mg ]}{( BW [ ml ] - V [ ml ] ) * F [ mol \text{/} l ]}$$

$$OH \text{-} number = \frac{( BW [ ml ] - V [ ml ] ) * F [ mol \text{/} l ] * M [ g \text{/} mol ]}{IW [ g ]}$$

with
IW=initial weight
BW=blank value
V=volume
F=concentration of standardized titrant
M=56.11 [g/mol]

### Mn=56100/OH-number

Mn=OH-equivalent*number of the OH groups in the molecule

For polyethylene glycol having a number average molecular weight in the range of 10,000 to 200,000 size exclusion chromatography (SEC) can be used.

The polymer is dissolved in tetrahydrofuran as mobile phase (THF, p.a., stabilized with BHT) and then analyzed by SEC with a differential refractometer detector. Molecular weight characterization is achieved by regression analysis of external polyethylene glycol (PEG) standards (8 SEC standards, 420 to 108,000 g/mol, e.g. from Fluka).

The analysis is done with a liquid chromatograph being able to deliver a constant longterm flow of 1.0 ml/min equipped with a differential refractometer (refractive index detector) and an electronic integrator, together with a column SDV, 8.0 mm×30 cm with particle size of 5 microns, columns with 10,000 Å, 500 Å and 100 Å; from PSS, Mainz, Germany, and a pre-column SDV, 8.0×50 mm with particle size of 10 microns, 100 Å; from PSS, Mainz, Germany. The flow rate should be 1.0 ml/min.

WinGPC, Size Exclusion Chromatography software from PSS, Mainz, Germany can be used to analyze the data obtained.

The average retention times for all the PEG standards is calculated, as well as the log₁₀ MW for all the PEG standards. A PEG Molecular Weight (MW) calibration curve is constructed and the average retention times are plotted vs. log₁₀ MW for the PEG standards to obtain a third order polynomial fit. The correlation coefficient (R2) should be >0.99. The molecular weight of the PEG sample using the SEC software is calculated. Values for Peak MW (MP), Weight Average MW (MW), Number Average MW (MN), and Polydispersity (DP) can be obtained.

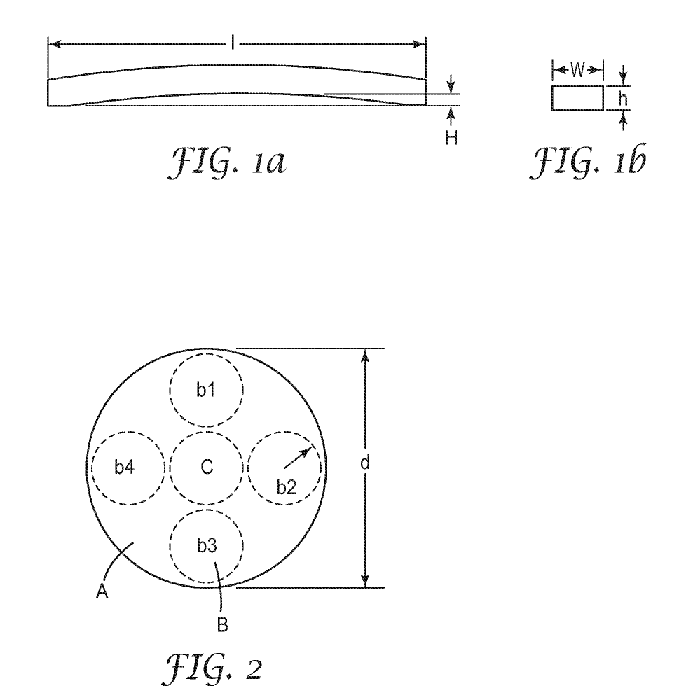

FIG. 1 shows a typical test bar used for evaluating the deformation of the coloured ceramic framework after firing.

FIG. 2 shows a typical ceramic disc (Zirconia) used for evaluating the results of the homogeneity of the colouring process.

### ABBREVIATIONS

h height; 2.3 mm
w width; 3.1 mm
l length; 37.0 mm
H indicates sintering deformation
A specimen/disc, thickness of disc; 1.5 mm
B measured areas
r radius; 3.0 mm
d sample diameter; 15.0 mm
c centre
b 1 border 1
b 2 border 2
b 3 border 3
b 4 border 4
L brightness (100=white, 0=black)
a* red-green axis
b* yellow-blue axis

The tests for evaluating the deformation of the coloured ceramic framework were performed as follows:

The rod-shaped samples (dimensions h*w*l: 3*4*48 [mm]; before sintering) were processed similar to a Lava™ bridge (milling, dyeing and sintering) with a commercial Lava™ equipment:

The presintered Zirconia (a Lava™ Frame blank for bridges) were milled, thereafter the dust was removed with microbrushes and compressed air. The milled sample was dipped in one of the Lava™ frame shade dying liquids (F5, F5*) for two minutes. After that any excessively adhering dyeing liquid was removed with an absorbent paper. Each sample was placed on two Lava™ sintering supports (20 mm distance) for posterior bridges (curved platinum wire). The proportion between sample length and distance between the wires was like the sintering of a bridge. The firing was done in a Lava™ Therm furnace with the standard sintering program.

After sintering the deformation of the samples, indicated with H, was measured with a profile projector.

The frame shade solutions used were nominated as FS 5 (solution not containing polyethylene glycol) and FS 5* (solution containing polyethylene glycol). The solution FS 5 comprised 1.9% by weight metal ions, 1.5% by weight organic binder. The solution FS 5* further comprised 6% by weight of PEG (Mn=35,000).

TABLE 1

| | | Frame Shade | | | | |
|---|---|---|---|---|---|---|
| | | FS 5 | FS 5* | FS 5* | FS 5* | uncoloured |
| Drying time | | 3.5 h | 3.5 h | 3 h | No | n. a. |
| Furnace, r. t. | | Y | Y | air | | n. a. |
| | | H [mm] | H [mm] | H [mm] | H [mm] | H [mm] |
| Sample | 1 | 0.258 | 0.056 | 0.034 | 0.143 | 0.033 |
| No | 2 | 0.192 | 0.054 | 0.026 | 0.145 | 0.034 |
| | 3 | 0.179 | 0.052 | 0.032 | 0.156 | 0.048 |
| | 4 | 0.152 | 0.072 | 0.014 | 0.122 | 0.039 |
| | 5 | 0.192 | 0.070 | 0.034 | 0.075 | 0.036 |

| | | | | | |
|---|---|---|---|---|---|
| Average [mm] | 0.200 | 0.061 | 0.028 | 0.128 | 0.038 |
| St. dev. [mm] | 0.033 | 0.009 | 0.008 | 0.032 | 0.006 |

It becomes clear from table 1 above that using a colouring solution containing polyethylene glycol instead of a colouring solution not containing polyethylene glycol the deformation of the tinted test bars measured after firing can be reduced.

### Homogeneity of Tinted Zirconia Discs

The homogeneity was determined using a commercially available Hunter Lab System and measured according to DIN 5033 Farbmessung Teil 1-8 (Normvalenz-System, L*a*b*-Farbraum nach CIE, 1976); DIN 6174 Farbmetrische Bestimmung von Farbabständen bei Körperfarben nach der CIE-LAB-Formel; DIN 55981 (ISO 787-25) Farbabstandsbestimmung ΔE* using standard operating procedures according to the manufacturer's operation manual (Hunter Lab., Coorp.) to determine the sample dimension, the calibration and measure procedure.

Further hints to this measuring system can also be found in DE 100 52 203 A1 on page 3, line 56 to page 4, line 6 which is incorporated by reference.

The frame shade solutions used are nominated as FS 4 and 6 (solution not containing polyethylene glycol) and FS 4* and 6* (solution containing polyethylene glycol).

The solution FS 4 comprised 5.0% by weight metal ions, 1.5% by weight organic binder. The solution FS 4* comprised in addition 6.0% by weight PEG 35,000 (Mn=14,000 to 19,000).

The solution FS 6 comprised 1.4% by weight metal ions, 1.5% by weight organic binder. The solution FS 6* comprised in addition 6.0% by weight PEG 35,000 (Mn=14,000 to 19,000).

TABLE 2
Bottom Side

| FS 4 | L* | a* | b* | Opac. |
|---|---|---|---|---|
| centre | 68.65 | 2.80 | 24.52 | 92.52 |
| border 1 | 69.20 | 2.53 | 24.27 | 92.63 |
| border 2 | 68.76 | 2.71 | 24.69 | 92.29 |
| border 3 | 68.87 | 2.78 | 24.89 | 92.44 |
| border 4 | 68.98 | 2.71 | 24.82 | 92.43 |
| Diff. min/max | 0.55 | 0.27 | 0.62 | 0.34 |
| average | 68.89 | 2.71 | 24.64 | 92.46 |
| St. dev. (%) | 0.212 | 0.106 | 0.249 | 0.125 |

TABLE 3

Upper Side

| FS 4 | L* | a* | b* | Opac. |
|---|---|---|---|---|
| centre | 67.71 | 3.77 | 27.11 | 91.99 |
| border 1 | 67.29 | 4.07 | 28.65 | 91.81 |
| border 2 | 67.62 | 3.73 | 27.31 | 91.75 |
| border 3 | 67.84 | 3.69 | 27.20 | 91.91 |
| border 4 | 67.97 | 3.66 | 27.24 | 91.92 |
| Diff. min/max | 0.68 | 0.41 | 1.54 | 0.24 |
| average | 67.69 | 3.78 | 27.50 | 91.88 |
| St. dev. (%) | 0.258 | 0.165 | 0.646 | 0.095 |
| Diff. upper/ | 1.21 | −1.08 | −2.86 | 0.59 |
| bottom side | | | | |

TABLE 4
Bottom Side

| FS 4* | L* | a* | b* | Opac. |
|---|---|---|---|---|
| centre | 67.87 | 3.41 | 26.55 | 92.87 |
| border 1 | 67.92 | 3.43 | 26.75 | 92.74 |
| border 2 | 67.92 | 3.35 | 26.56 | 92.60 |
| border 3 | 67.82 | 3.45 | 26.96 | 92.62 |
| border 4 | 67.87 | 3.47 | 26.96 | 92.72 |
| Diff. min/max | 0.10 | 0.12 | 0.41 | 0.27 |
| average | 67.88 | 3.42 | 26.76 | 92.71 |
| St. dev. (%) | 0.042 | 0.046 | 0.203 | 0.108 |

TABLE 4a

Upper Side

| FS 4* | L* | a* | b* | Opac. |
|---|---|---|---|---|
| centre | 67.17 | 4.13 | 26.42 | 92.53 |
| border 1 | 67.32 | 4.09 | 26.62 | 92.48 |
| border 2 | 67.34 | 4.06 | 26.33 | 92.34 |
| border 3 | 67.52 | 3.97 | 26.12 | 92.39 |
| border 4 | 67.46 | 4.01 | 26.38 | 92.63 |
| Diff. min/max | 0.35 | 0.16 | 0.50 | 0.29 |
| average | 67.36 | 4.05 | 26.37 | 92.47 |
| St. dev. (%) | 0.136 | 0.063 | 0.180 | 0.115 |
| Diff. upper/ | 0.52 | −0.63 | 0.38 | 0.24 |
| bottom side | | | | |

TABLE 5
Bottom Side

| FS 6 | L* | a* | b* | Opaz. |
|---|---|---|---|---|
| centre | 67.99 | 0.11 | 22.10 | 93.98 |
| border 1 | 68.41 | −0.13 | 21.32 | 94.12 |
| border 2 | 68.43 | −0.14 | 21.41 | 93.94 |
| border 3 | 67.96 | 0.20 | 22.64 | 93.79 |
| border 4 | 68.15 | 0.12 | 22.37 | 93.96 |
| Diff. min/max | 0.47 | 0.34 | 1.32 | 0.33 |
| Average | 68.19 | 0.03 | 21.97 | 93.96 |
| St. dev. (%) | 0.224 | 0.156 | 0.583 | 0.118 |

TABLE 6

Upper Side

| FS 6 | L* | a* | b* | Opaz. |
|---|---|---|---|---|
| center | 67.31 | 0.38 | 23.61 | 93.65 |
| border 1 | 66.64 | 0.71 | 25.01 | 93.13 |
| border 2 | 67.00 | 0.52 | 24.47 | 93.02 |
| border 3 | 68.01 | 0.09 | 22.56 | 93.50 |
| border 4 | 67.63 | 0.28 | 23.22 | 93.59 |
| Diff. min/max | 1.37 | 0.62 | 2.45 | 0.63 |
| average | 67.32 | 0.40 | 23.77 | 93.38 |
| St. dev. (%) | 0.533 | 0.235 | 0.977 | 0.284 |
| Diff. upper/ | 0.87 | −0.36 | −1.81 | 0.58 |
| bottom side | | | | |

TABLE 7
Bottom Side

| FS 6* | L* | a* | b* | Opaz. |
|---|---|---|---|---|
| centre | 67.19 | 0.14 | 21.15 | 94.34 |
| border 1 | 67.21 | 0.10 | 21.36 | 94.22 |
| border 2 | 67.34 | 0.06 | 20.92 | 94.24 |
| border 3 | 67.32 | 0.09 | 21.04 | 94.17 |
| border 4 | 67.26 | 0.10 | 21.03 | 94.14 |
| Diff. min/max | 0.15 | 0.08 | 0.44 | 0.20 |
| Average | 67.26 | 0.10 | 21.10 | 94.22 |
| Std. dev. (%) | 0.066 | 0.029 | 0.167 | 0.077 |

TABLE 8

Upper Side

| FS 6* | L* | a* | b* | Opaz. |
|---|---|---|---|---|
| Center | 67.03 | 0.22 | 20.34 | 94.13 |
| border 1 | 67.13 | 0.18 | 20.07 | 94.19 |
| border 2 | 67.17 | 0.17 | 20.29 | 94.02 |
| border 3 | 67.32 | 0.11 | 20.01 | 94.11 |
| border 4 | 67.08 | 0.17 | 20.39 | 94.01 |
| Diff. min/max | 0.29 | 0.11 | 0.38 | 0.18 |
| Average | 67.15 | 0.17 | 20.22 | 94.09 |
| St. dev. (%) | 0.111 | 0.039 | 0.169 | 0.076 |
| Diff. upper/ | 0.12 | −0.07 | 0.88 | 0.13 |
| bottom side | | | | |

From the above tables 2 to 8 it becomes clear that using a colouring solution containing polyethylene glycol instead of a colouring solution not containing polyethylene glycol the homogeneity of the tinted discs can be improved.

1. A process for treating a dental ceramic framework, the process comprising:
a) providing a presintered ceramic framework;
b) providing a colouring solution comprising:
i) a solvent;
ii) a metal salt or metal complex, soluble in the solvent, wherein the amount of the metal ions in the composition is in the range of 0.01 to 7.0% by weight; and
iii) polyethylene glycol having a Mn in the range of 10,000 to 50,000 in an amount of 1 to 8% by weight of the total composition;
wherein the metal salt is selected from rare earth elements and/or the subgroups of the rare earth elements and/or salts of transition metals of the groups IIIA, IVA, VA, VIA, VIIA, VIIIA, IB, IIB;
c) treating the presintered ceramic framework with the colouring solution to form a treated presintered ceramic framework; and
d) firing the treated presintered ceramic framework.

2. The process of claim 1, further comprising the step of drying the treated ceramic framework after it has been treated with the solution.

3. The process according to claim 1, wherein the presintered ceramic framework is treated with the solution for about 1 to 5 minutes at room temperature.

4. The process according to claim 1, wherein the firing takes place for a ZrO₂ based ceramic at a temperature above 1300° C. and lasts for at least 0.5 h and for a Al₂O₃ based ceramic at a temperature above 1350° C. and lasts for at least 0.5 h.

5. The process according to claim 1, wherein the firing takes place at a temperature above about 1300° C.

6. The process according to claim 8, wherein treating the presintered ceramic framework comprises dipping the framework into the solution, spraying the solution onto the framework, brushing the solution onto the framework, or by using a sponge or fabric to apply the solution to the framework.

7. The process of claim 1, wherein the ceramic framework is selected from presintered bodies comprising ZrO₂ and/or Al₂O₃.

8. The process of claim 1, wherein the colouring solution does not include pigments.

9. A process of reducing the sintering deformation of a dental ceramic framework during firing, the method comprising:
a) providing a dental ceramic framework;
b) providing a solution comprising:
i) a solvent;
ii) a metal salt or metal complex, soluble in the solvent, wherein the amount of the metal ions in the composition is in the range of 0.01 to 7.0% by weight; and
iii) polyethylene glycol having a Mn in the range of 10,000 to 50,000 in an amount of 1 to 8% by weight of the total composition;
wherein the metal salt is selected from rare earth elements and/or the subgroups of the rare earth elements and/or salts of transition metals of the groups IIIA, IVA, VA, VIA, VIIA, VIIIA, IB, IIB;
c) treating the ceramic framework with the solution to form a treated ceramic framework; and
d) firing the treated ceramic framework to form a sintered dental ceramic framework;
wherein the sintered dental ceramic framework has reduced sintering deformation compared to a dental ceramic framework fired the same way but without being treated with the solution.

10. The process of claim 9, wherein providing a dental ceramic framework comprises providing a presintered dental ceramic framework.

11. The process of claim 10, wherein the ceramic framework is selected from presintered bodies comprising ZrO₂ and/or Al₂O₃.

12. The process of claim 9, further comprising the step of drying the treated ceramic framework after it has been treated with the solution.

13. The process according to claim 9, wherein the ceramic framework is treated with the solution for about 1 to 5 minutes at room temperature.

14. The process according to claim 9, wherein the firing takes place for a ZrO₂ based ceramic at a temperature above 1300° C. and lasts for at least 0.5 h and for a Al₂O₃ based ceramic at a temperature above 1350° C. and lasts for at least 0.5 h.

15. The process according to claim 9, wherein the firing takes place at a temperature above about 1300° C.

16. The process of claim 9, wherein the solution does not include pigments.

17. A method for colouring a dental ceramic framework, the method comprising:
a) providing a dental ceramic framework;
b) providing a colouring solution comprising:
i) a solvent;
ii) a metal salt or metal complex, soluble in the solvent, wherein the amount of the metal ions in the composition is in the range of 0.01 to 7.0% by weight; and
iii) polyethylene glycol having a Mn in the range of 10,000 to 50,000 in an amount of 1 to 8% by weight of the total composition;
wherein the metal salt is selected from rare earth elements and/or the subgroups of the rare earth elements and/or salts of transition metals of the groups IIIA, IVA, VA, VIA, VIIA, VIIIA, IB, IIB;
c) treating the ceramic framework with the colouring solution to form a treated ceramic framework; and
d) firing the treated ceramic framework to form a sintered dental ceramic framework;
wherein the sintered dental ceramic framework has improved uniformity in colouring compared to a dental ceramic framework fired the same way but without being treated with the colouring solution.

18. The process of claim 17, wherein providing a dental ceramic framework comprises providing a presintered dental ceramic framework.

19. The process of claim 18, wherein the ceramic framework is selected from presintered bodies comprising ZrO₂ and/or Al₂O₃.

20. The process of claim 17, further comprising the step of drying the treated ceramic framework after it has been treated with the solution.

21. The process according to claim 17, wherein the ceramic framework is treated with the solution for about 1 to 5 minutes at room temperature.

22. The process according to claim 17, wherein the firing takes place for a ZrO₂ based ceramic at a temperature above 1300° C. and lasts for at least 0.5 h and for a Al₂O₃ based ceramic at a temperature above 1350° C. and lasts for at least 0.5 h.

23. The process of claim 17, wherein the colouring solution does not include pigments.
